(19) United States
(12) Patent Application Publication
(10) Pub. No.: US 2014/0287959 A1
(43) Pub. Date: Sep. 25, 2014

(54) NANOREACTOR PRINTING

(71) Applicants: Adam B. Braunschweig, New York, NY (US); Jiajun He, Jersey City, NJ (US); Shudan Bian, New York, NY (US); Kevin B. Schesing, Cliffisde Park, NJ (US)

(72) Inventors: Adam B. Braunschweig, New York, NY (US); Jiajun He, Jersey City, NJ (US); Shudan Bian, New York, NY (US); Kevin B. Schesing, Cliffisde Park, NJ (US)

(73) Assignee: New York University, New York, NY (US)

(21) Appl. No.: 14/129,233

(22) PCT Filed: Apr. 3, 2012
(86) PCT No.: PCT/US2012/032019

§ 371 Date: Mar. 18, 2014

Related U.S. Application Data
(60) Provisional application No. 61/501,623, filed on Jun. 27, 2011.

(51) Int. Cl. B01J 19/00

(52) U.S. Cl. CPC B01J 19/0046
USPC 506/13; 506/32

(57) ABSTRACT

Polymer Pen Lithography is used to induce bioorthogonal reactions between treated surfaces and functionalized inks create a soft matter layer. Fluorescent and redox-active inks were used to demonstrate that the molecules were immobilized covalently and achieves precise control over ligand orientation and density within each feature. Finally, the utility was demonstrated by creating functional arrays of biologically active probes.

### CROSS-REFERENCE TO RELATED APPLICATIONS

The application claims benefit of U.S. Provisional Application 61/501,623, filed Jun. 27, 2011, which is hereby incorporated by reference in its entirety.

### STATEMENT OF GOVERNMENT-SPONSORED RESEARCH

This invention was made with United States government support awarded by the following agencies: The Air Force Office of Scientific Research Young Investigator Award (FA9550-11-1-0032). The United States government has certain rights in the invention.

### FIELD OF THE INVENTION

The present invention relates generally to printing and patterning. Specifically, to small scale arrays such as micro- and nanoarrays via lithography.

### BACKGROUND OF THE INVENTION

Micro- and nanoarrays of organic and biologically active molecules (proteins, antibodies, oligonucleotides, sugars, peptides, etc.) immobilized onto a solid support have revolutionized biology, led to breakthroughs in biomedical research, and are now employed clinically to determine treatment courses for various diseases. Such arrays are increasingly employed in sensors, diagnostics, and fundamental biological studies. As a consequence, intensive research efforts are devoted to developing lithographic tools with high-throughput and low-cost that reduce feature dimensions into the sub-micrometer regime, increase detection sensitivity, and minimize the sample volume required to run assays. Ligand orientation and density are also pattern parameters that have been increasingly recognized as critical for creating surfaces to mimic the biological activity of lectin-carbohydrate or protein-ligand binding on cell surfaces, controlling stem-cell growth, and modifying the behavior of supramolecular host-guest arrays. Prior techniques have utilized binding affinity for ligand surface binding control for use with treated substrates.

For example, glycomics, an emerging area of biology that aims to understand the role of carbohydrates, glycolipids, and glycoproteins (glycans) in disease, could benefit greatly from the widespread use of microarrays, but unlike gene and antibody arrays, glycan chips are not widely employed because they remain expensive and difficult to obtain. Specifically, the preparation of glycan chips is complicated by (1) the large sample volumes of saccharides required to prepare microarrays by pin- or inkjet-printing, which are difficult to obtain because of the enormous synthetic effort required to prepare complex carbohydrates, and (2) the surface chemistries typically employed to make protein and gene arrays are often incompatible with the functional groups on carbohydrates. In addition, the orientation of glycans in arrays is particularly important because binding affinities between sugars and lectins (Kₐs) of 10²-10³ M⁻¹ are common, and binding is dependent on having high surface density, F, of oriented glycans. However, common immobilization strategies do not deposit all probes in an active orientation. Similarly, gene chips (or DNA microarrays), which are used to measure expression levels of a gene or genotype regions of a genome, are often cost-prohibitive because a large sample size is required. A reduction of feature size, and a corresponding reduction in required sample size, therefore, may improve the accessibility of such a tool.

Several organic reactions, such as those described below, are known to have utility in creating microarrays. However, of the thousands of known organic reactions, only approximately ten are presently used in arraying. There is, therefore, a need for further exploration of organic reactions to determine whether such methods may be extended.

The Cu^{I} catalyzed azide-alkyne cycloaddition (Cuaac), for example, is a powerful reaction for immobilizing biological probes because the alkyne and azide functional groups are bioorthogonal, the reaction proceeds quickly and in high yield, and as a result it has been adopted widely by researchers for applications in chemical biology, materials science, and nanotechnology. Moreover, the Cuaac is increasingly seen as a solution to the challenge of orientation and immobilization in glycan arrays. As a result, there is a need for new patterning tools that can substantially reduce the amount of materials required to print glycan arrays and can site-specifically induce the formation of carbohydrate-compatible surface reactions like the Cuaac.

The Staudinger Ligation, which is commonly used to covalently link fluorescent molecules with biological substrates by the formation of amide bonds rapidly and without catalysts, has also been investigated as a reaction for making microarrays of biologically active probes, although to date only with large spot sizes (>50 μm). However, the sensitivity of the phosphine to oxidation and the low-water solubility of aryl-phosphines has prevented the use of this reaction in molecular printing.

Conventional nanolithography strategies—e.g. photolithography, electron beam lithography (e-beam), and focused ion beam lithography—invoke high energy radiation that would denature or damage soft matter. Alternatively, widely utilized methods for preparing biological microarrays, like pin-printing or droplet-deposition, are incapable of creating sub-micrometer features, which minimizes the usage of difficult-to-obtain samples such as carbohydrates. Parylene peel-off, which can create multicomponent arrays with sub-100 nm feature dimensions and has been utilized to study cell-cell adhesion, shows promise as a route towards combinatorial nanoarrays but involves an e-beam writing step, which is inherently low-throughput. Other promising method to create bioarrays, involving photochemical deprotection of surface groups or near-field scanning optical methods, have low-throughput or cannot create sub-micrometer features. Molecular printing strategies deposit ink directly onto a surface with at least one feature dimension on the molecular scale and are the most promising approach to creating large area (>cm²) nanoarrays of soft matter. Microcontact printing (μCp) and Dip-pen nanolithography (DPN) are widely utilized molecular printing methods, but each has drawbacks that limit their broader use. μCp employs elastomeric stamps with photolithographically predefined patterns to transfer inks to surfaces, but it is difficult create sub-500 nm features with μCp because of roof collapse and bending that occur as a consequence of the materials properties of the elastomer used to fabricate the stamps. DPN is a scanning-probe based molecular printing strategy that prepares arbitrary patterns of features with diameters as small as 15 nm and has been used to pattern lipids, proteins, DNA, and create photonic devices, but its low-throughput and the necessity to optimize the transport of each new ink through the aqueous meniscus limits its utility.

Polymer Pen Lithography (PPL) employs massively parallel tip arrays containing as many as 10⁷ elastomeric pyramids that, upon mounting onto the piezoactuators of an atomic force microscope (AFM), delivers ink site-specifically onto a surface into arbitrary patterns with feature diameters ranging from 80 nm to over 100 μm in a single writing operation, thereby overcoming the feature size and throughput limitations of μCP and DPN, respectively. The use of elastomeric pyramidal arrays as a writing tool was first demonstrated in the context of a μCp experiment, but PPL has superior pattern control and feature resolution because of its computer-controlled piezoactuation. Additionally, PPL has been used to print multiplexed antibody arrays, wherein different inks are deposited simultaneously by each tip. As a consequence, PPL may solve challenges associated with printing glycan arrays by significantly reducing feature diameters by simultaneously implementing carbohydrate compatible surface immobilization reactants.

Furthermore, the polydimethylsiloxane (PDMS) polymer that comprises the tips provides a novel printing capability that is present in PPL but absent in DPN: The linear relationship between dwell time and feature diameter characteristic of DPN is maintained in PPL, but a new linear relationship between force and feature edge length arises because of the compression of the elastomeric tips. This compression has been used to level the pen arrays with respect to the surfaces so uniform features are written across the >1 cm length of the arrays. Importantly, the cost of a PPL pen array (˜$1) is significantly lower than a single AFM probe, and patterns containing multiple proteins have been prepared by using the master in which the tips were fabricated as ink wells to place a different protein solution on each tip.

In traditional PPL and DPN, the inks must diffuse through an aqueous meniscus, and differences in solubility and diffusion rates necessitate the optimization of patterning conditions for each ink or could preclude the deposition of certain inks altogether. Various strategies, including redox-activating DPN or agarose- and lipid-assisted DPN have been developed to circumvent the issue of differential transport rates. Matrix-assisted polymer pen lithography (MA-PPL) utilizes the amphiphilc polymer poly(ethylene glycol) (PEG) as a transport matrix that encapsulates the ink and transports it to the surface to produce uniform patterns regardless of the ink solubility. The transport matrix is then selectively washed away or removed, such as by ablation or washing with an appropriate solvent.

However, there remains a need for reliable, high-throughput techniques that induce and contain covalent reactions at the sub-micrometer scale while maintaining the orientation of the biological probes necessary to facilitate binding. Such techniques would reduce the quantity of material needed, increase the density of spots on any chip created for an assay, thus increasing sensitivity, and, furthermore, would allow for uniformity of distribution of spots over a given surface.

### SUMMARY OF THE INVENTION

The present invention relates to surface chemistry, ink transport, and characterization techniques for PPL-induced covalent reactions, developed to address the problems with existing techniques outlined above.

In one aspect, the present invention provides a system for creating an array comprising: a substrate having a first functional group; at least one ink having a carrier and soft matter with a second functional group that is complementary to the first functional group; the substrate and the ink forming a nanoreactor, the nanoreactor confined to a reaction space bounded by the substrate and the carrier; and the soft matter suspended in the carrier such that the soft matter is movable within the carrier and movable with respect to the first functional group of the substrate, wherein the soft matter aligns to react with the first functional group to become bound to the substrate.

In some embodiments, the ink may further include a catalyst, such as, in further embodiments, Cu^{I}. In further embodiments, other non-catalytic agents may be present, such as, for example, a reducing agent. The carrier may, in some embodiments, be polyethylene glycol. The reducing agent may be ascorbic acid in some embodiments. The first functional group may be an azide, while the second functional group may, in further embodiments, be an alkyne or aryl phosphine. In some embodiments, the soft matter may comprise a biological probe such as, in further embodiments, a sugar, an antibody, a peptide, or an oligonucleotide.

In another aspect, a system is provided for creating an array comprising: a substrate having a first functional group; at least one ink having a carrier and soft matter with fluorescent, redox active, or biological probe components that react with the first functional group; the carrier and the ink forming a nanoreactor, the nanoreactor confined to a reaction space bounded by the substrate and the carrier; and the soft matter suspended in the carrier such that the soft matter is movable within the carrier and movable with respect to the first functional group of the substrate, wherein the soft matter aligns to react with the first functional group to become covalently bound to the substrate. In some embodiments, the redox active component may be ferrocene phosphine. In further embodiments, the fluorescent component may be rhodamine phosphine. Additionally, the soft matter may comprise a biological probe, such as a sugar, an oligonucleotide, a peptide, or an antibody. In still further embodiments, the first functional group may be an azide, and the second functional group may be either an alkyne or aryl phosphine.

In yet another aspect, the present invention provides a method for creating an array comprising: preparing a substrate with a first functional group; preparing soft matter with a second functional group complementary to the first functional group; forming an ink comprising a carrier and the prepared soft matter; depositing the ink on the substrate to form a nanoreactor; and facilitating an orientation specific reaction of the first functional group and the second functional group.

In some embodiments, the first functional group may be an azide. In further embodiments, the second functional group may be an alkyne or aryl phosphine, and, in some embodiments, the carrier may be polyethylene glycol. The step of forming the ink may further comprise adding a polymer or a catalyst, the latter of which may, in some embodiments, be Cu¹. The carrier may form microcapsules or nanocapsules encompassing the remaining ink components, and those microcapsules or nanocapsules may, in some embodiments, define the spatial parameters of the orientation specific reaction. In some embodiments, about 1 nL of ink may be deposited. In still further embodiments, the step of preparing a second soft matter a third functional group complementary to the first functional group may also be included.

In yet further embodiments, the steps of forming a second ink comprising a second carrier and the prepared second soft matter; depositing the second ink on the substrate to form a second nanoreactor; and facilitating an orientation specific reaction of the first functional group and the third functional group may also be included. In such embodiments, the step of, prior to depositing, mixing the first ink and the second ink, may be included.

In still another aspect, a method is provided for creating an array comprising: preparing a substrate with a first functional group; preparing soft matter comprising a fluorescent, redox active, or biological probe component; forming an ink comprising a carrier and the prepared soft matter, wherein the carrier forms microcapsules or nanocapsules encompassing the prepared soft matter; depositing the ink on the substrate to form a nanoreactor; and facilitating an orientation specific reaction of the first functional group and the second functional group.

In some embodiments, the redox active component may be ferrocene phosphine, or a derivative thereof. In further embodiments, the fluorescent component may be rhodamine phosphine or a derivative thereof. The carrier may, in some embodiments, be polyethylene glycol. In still further embodiments, the formation of the ink may further comprise adding a polymer. Additionally, the soft matter may, in some embodiments comprise a biological probe, such as a sugar, an oligonucleotide, a peptide, or an antibody. In still further components, the first functional group may be an azide, and the second functional group may be either an alkyne or aryl phosphine.

In yet another aspect, the present invention provides a composition comprising: a substrate having a first functional group bound thereto; a monolayer comprising a plurality of soft matter components bound to the first functional group, each of the soft matter components having the same orientation with regard to the substrate

Additional features, advantages, and embodiments of the present disclosure may be set forth from consideration of the following detailed description, drawings, and claims. Moreover, it is to be understood that both the foregoing summary of the present disclosure and the following detailed description are exemplary and intended to provide further explanation without further limiting the scope of the present disclosure claimed.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 illustrates Site-specific Cu^{I}-catalyzed azide-alkyne cycloaddition (Cuaac) induced by Polymer Pen Lithography (PPL): (a) The surface is functionalized to create an azide-terminated monolayer; (b) the alkyne-containing molecule and the Cu^{I} catalyst are delivered in a poly(ethylene glycol) (PEG) matrix by a PPL tip array; (c) the PEG nanoreactors are washed away, leaving (d) a monolayer of the molecule of interest (R) covalently immobilized only where the features had been patterned by PPL;

FIG. 2A are fluorescent microscopy images (Nikon Eclipse Ti, λₑₓ=532-587 nm, λ_{obs}=608-683 nm) of dot arrays of fluorescent ink 1 encapsulated within a PEG matrix patterned onto azido-terminated glass slide by an 8500 pen PPL array. 11×11 Dot arrays were fabricated with different dwell times in each row (10, 20, 50, 100, 200, 500, 1000, 2000, 5000, 10000, 20000 ms, from bottom to top) with the inset showing a higher magnification image of an array printed by a single PPL tip; FIG. 2B is a Flourescence image taken of the same array as FIG. 2A after reacting for 16 h followed by washing with 50 mL H₂O and 50 mL EtOH. Inset shows a higher magnification image of an array printed by a single PPL tip; FIG. 2C shows the feature sizes were measured by non-contact AFM and fluorescence microscopy prior to and after washing away the PEG nanoreactors, and by fluorescence microscopy following washing away of the PEG nanoreactors, the linear relationship between the feature diameter of the dots and the square root of the dwell time^{1/2} is maintained; FIG. 2D is a fluorescence image of an array patterned by a single pen following washing; FIG. 2E is an intensity profile of the dot row produced using 1000 ms dwell time from (FIG. 2D). The signal-to-noise ratio is approximately 1.5:1; FIG. 2F is an AFM non-contact image of a dot array produced by a single pen; FIG. 2G Non-contact AFM image of one dot which was produced using 10 ms dwell time.

FIG. 3A is an optical microscope image showing PPL-patterned dot arrays of PEG/2 nanoreactors on the azido terminated Au surface; FIG. 3B is an AFM tapping mode image of a 20×20 dot array with the height profile superimposed; FIG. 3C illustrates a cyclic Voltammetry (CV) characterization of the Au surface patterned with a χ=100% ink mixture of 2 using a Pt counter electrode and Ag/AgCl/KCl reference electrode in 1M HClO₄ electrolyte solution; different colors of the curves indicate different scan rates (0.05, 0.10, 0.15, 0.20, 0.25, 0.30 V/s from red to purple); FIG. 3D is an chart of surface density of 2 within the patterned features as a function of the % of 2 in a mixture of 2 and 1-hexyne, χ. Triangles (▴) indicate surfaces with monolayer coverage of 2, and open squares (□) indicate PPL patterned surfaces (dotted line indicates the theoretical maximum density).

FIG. 4A illustrates the structure of alkyne-containing fluorescent Rhodamine-derivative, 1; FIG. 4B illustrates the structure of alkyne containing redox active ferrocene ink, 2. FIG. 4C illustrates the reaction for preparation of azide-terminated glass surface and functionalization with 1: i. disuccinimidyl glutaric dicarboxylate, N,N-diisopropylethylamine, 3-azidopropylamine, DMF. ii. 1 mM CuSO₄, 4 mM sodium ascorbate, 1, PEG (2000 g mol⁻¹), 80:20 EtOH:H₂O; FIG. 4D illustrates the reaction for preparation of azide terminated Au surface and functionalization with 2: iii. 1 mM 11-Azidoundecane-1-thiol, EtOH, 24 h; iv. 1 mM CuSO₄, 4 mM sodium ascorbate, 1, PEG (2000 g mol⁻¹), 80:20 EtOH:H₂O.

FIG. 5A is a schematic diagram showing the Cu1-catalyzed azide alkyne click reaction (Cuaac). FIG. 5B shows the putative structure of the ink molecules used in the PPL-induced Cuaac delineated in FIG. 5A as determined using NMR and high resolution mass spectra.

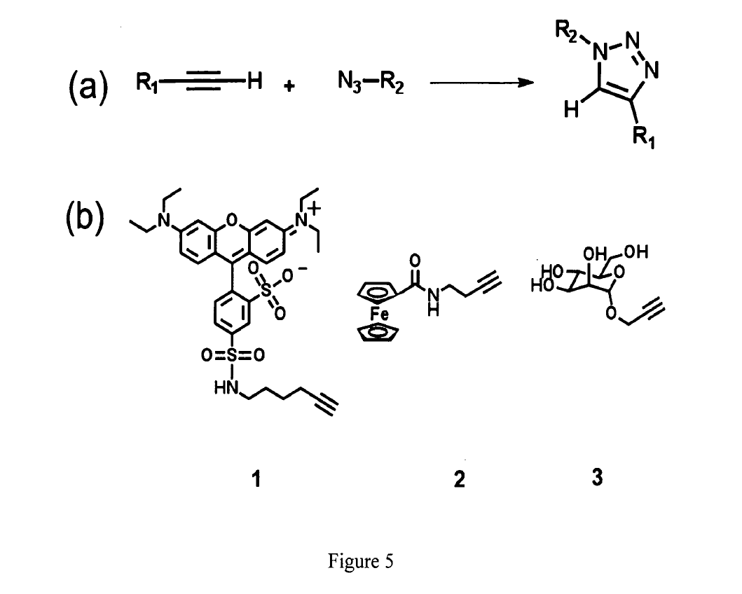

FIG. 6 is a representation of PPL-induced site-specific Cuaac. FIG. 6A represents a PPL tip-array; FIG. 6B represents the PPL tip-array coated with an ink mixture consisting of alkyne, PEG, Cu^{I}-coated catalyst, and reducing agent; FIG. 6C shows the inked tip array being brought into contact with an azido-terminated surface to form patterns. FIG. 6D represents the PEG nanoreactors are left on the surface so that the Cuaac reaction can proceed; FIG. 6E represents that, following the rinsing of the surface to remove the PEG, only the covalently immobilized molecules remain patterned onto the surface.

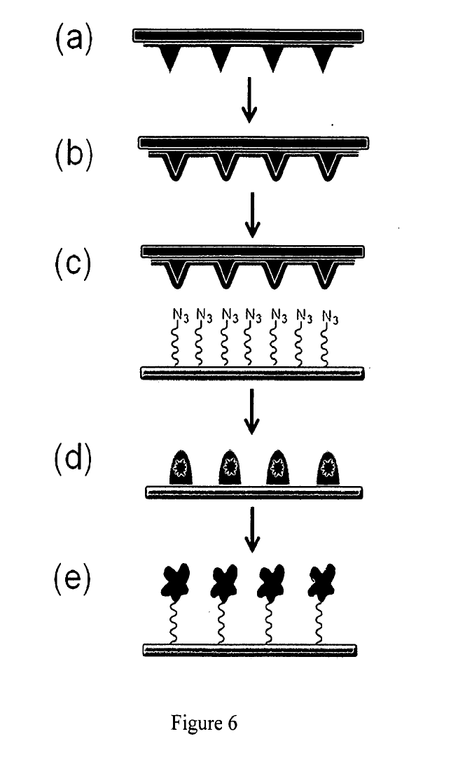

FIG. 7 shows the fluorescent patterns produced by the site-specific Cuaac reaction. FIG. 7A shows a schematic of an ink mixture consisting of 1, PEG, CuSO₄, and sodium ascorbate printed onto an azido-terminated glass slide results in covalent immobilization of rhodamine. FIG. 7B is a photograph of a fluorescent microscope image (Nikon Eclipse Ti, λₑₓ=532-587 nm, λ_{obs}=608-683 nm) of 11×11 dot arrays of 1 with varying dwell times (10, 20, 50, 100, 200, 500, 1000, 2000, 5000, 10000, 20000 ms, from bottom to top) were patterned by each pen in the PPL tip array. Inset is a magnified image of one array. FIG. 7C shows the intensity profile of the dot row produced using 1000 ms dwell time. The signal-to-noise ratio is approximately 1.5:1. FIG. 7D is a histogram showing that the linear relationship between the feature diameter of the dots and the square root of the dwell time is maintained.

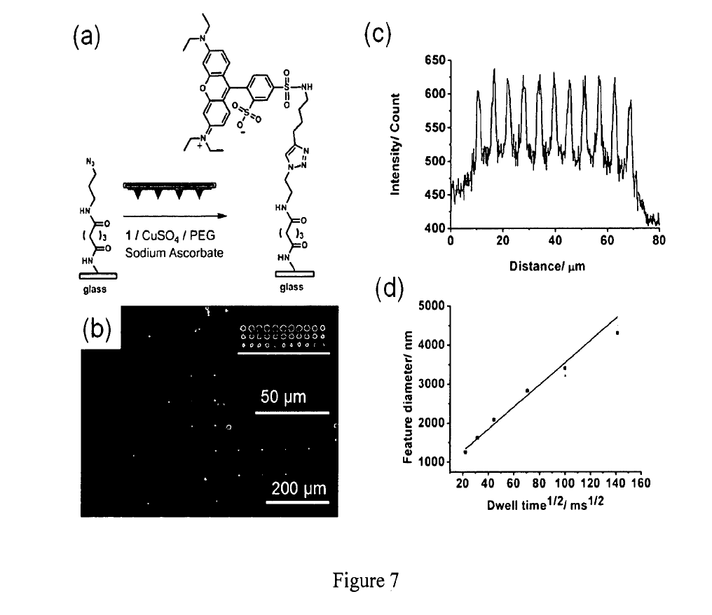

FIG. 8 shows the redox active patterns created by combining the Cuaac and PPL. FIG. 8A is a schematic showing that an ink mixture consisting of 2, PEG, CuSO₄, and sodium ascorbate are printed onto an azido-terminated glass slide results in covalent immobilization of ferrocene. FIG. 8B is an optical microscope image showing PPL-patterned dot arrays of PEG/2 nanoreactors on the azido-terminated Au surface. FIG. 8C is a Cyclic Voltammetry (CV) characterization of the Au surface patterned with 2 using a Pt counter electrode and Ag/AgCl reference electrode in 1M HClO₄ electrolyte solution with different scan rates (0.05, 0.10, 0.15, 0.20, 0.25, 0.30 V/s). FIG. 8D is a histogram showing the linear relationship between scan rate and current.

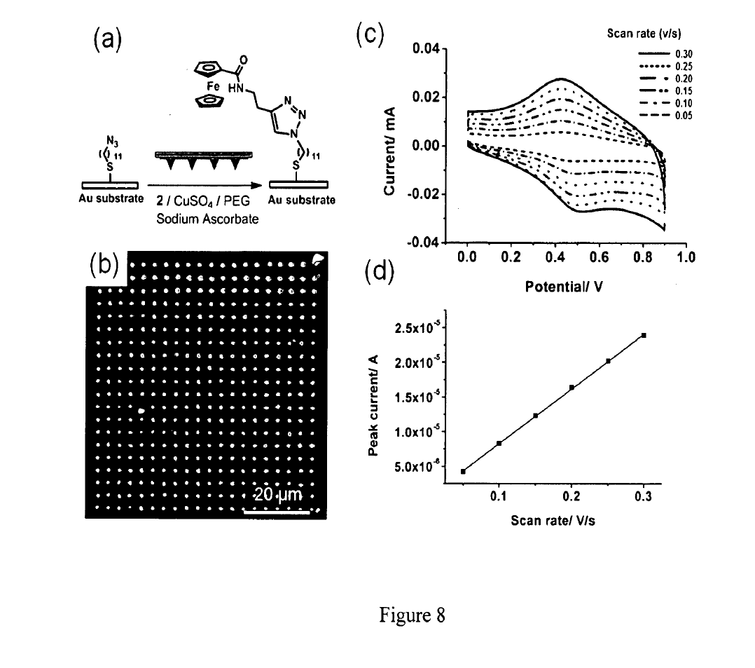

FIG. 9 shows the intensity profile and uniform density of nanoreactor placement as shown in a functional glycan array prepared by PPL-induced covalent immobilization of α-D-mannoside, 3. FIG. 9A shows an ink mixture consisting of 3, PEG, CuSO₄, and sodium ascorbate are printed onto an azido-terminated glass slide results in covalent immobilization of mannose. FIG. 9B is a fluoresence microscopy image (Nikon Eclipse Ti, λₑₓ=532-587 nm, λ_{obs}=608-683 nm) of a surface patterned with 3 and exposed to a solution of Cy3-modified ConA. FIG. 9C is a magnified image of a single 4×4 array, wherein the white line indicates the dots whose intensity profile is shown. FIG. 9D is a graph showing the intensity profile of a single line of a 4×4 pattern of dots. The signal to noise ratio for the exposed patterns is 1.5:1.

FIG. 10A is a representation of the Staudinger ligation on an azido-terminated surface. FIG. 10B shows the structure of the fluorescent and redox-active ink molecules used in MA-PPL induced Staudinger Ligation

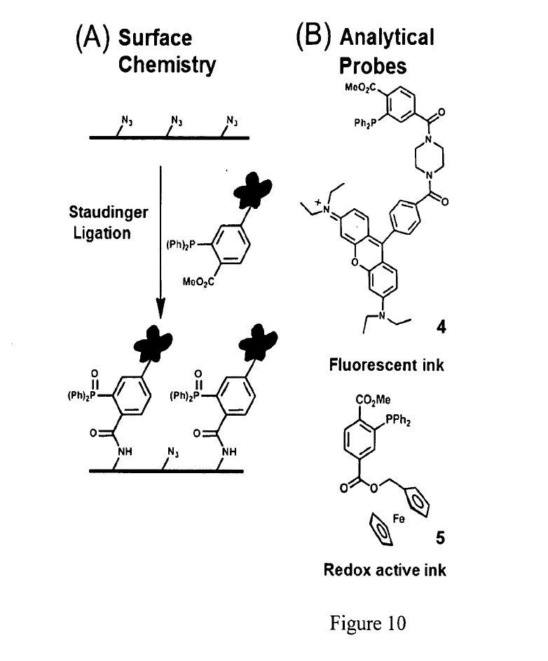

FIG. 11 is a fluorescent microscope image (Nikon Eclipse Ti, λₑₓ=532-587 nm, λ_{obs}=608-683 nm) of 8×8 dot patterns of 4 produced by each tip in the Staudinger Ligation array. Inset is a magnified image of one array with dwell times of 20, 10, 2, 1, 0.5, 0.1, 0.05, 0.02 s from bottom to top.

FIG. 12 is a pair of graphs showing, in FIG. 12A, the intensity profile of the dot row produced using 0.5 s dwell time (indicated by the line in FIG. 11, inset). The signal-to-noise ratio is approximately 1.5:1. FIG. 12B is a histogram showing the linear relationship between the feature diameter of the dots and the square root of the dwell time is maintained, with saturation at high dwell times, as previously observed.

FIG. 13 is an optical image (Nikon Ni-U, 10× magnification) of an ink mixture consisting of 5 and PEG printed onto an azido-terminated glass slide produced by MA-PPL patterning.

FIG. 14A is a graph showing a Cyclic voltammetry (CV) characterization of the Au surface patterned with 5 using a Pt counter electrode and Ag/AgCl reference electrode in 1M HClO₄ electrolyte solution. FIG. 14B is a graph showing the linear relationship between scan rate and current.

### DETAILED DESCRIPTION OF THE PREFERRED EMBODIMENTS

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

As feature sizes are reduced to the nanoscale, effective concentration becomes increasingly important because there are fewer molecules available for binding, and a small percentage of misaligned ligands could disproportionately reduce affinity below detectable limits. As a consequence, there is a need for tools that can create sub-micrometer diameter features and that control precisely the orientation and density of the organic and biological molecules within nanoarrays.

The present invention relates to apparatus, processes, and compositions of matter for printing or patterning such as creating soft-matter arrays. Printing techniques for use with the present invention include, but are not limited to, Polymer Pen Lithography (PPL), micro-contact printing (mCp), dip-pen nanolithography (DPN), ink jet printing, or other printing/deposition techniques. In one embodiment, the soft matter arrays may be printed over large areas (>1 cm²) with feature diameters as small as about 200 nm and with control over ligand orientation and density by employing PPL to induce a chemically specific surface reaction, including but not limited to covalent and noncovalent interactions.

While PPL offers advantages in terms of throughput, feature size, and pattern flexibility over other molecular printing approaches, it does not provide a mechanism to control the ligand orientation and density within features. The challenges to inducing site-specific covalent reactions by PPL include the selection of appropriate surface chemistry, developing deposition conditions so all inks move through the meniscus uniformly, and devising a strategy that accommodates the time required for multicomponent reactions to occur without ink spreading and a subsequent feature size increase.

The present invention relates to the use of polymer pen lithography to create a nanoreactor on the surface of a substrate. The surface of the substrate is prepared, such as by binding a functional group to the surface. Any functional group capable of immobilizing on the surface of the substrate and forming a covalent bond with a complementary functional group may be used. In preferred embodiments, the functional group will be capable of undergoing a Cuaac reaction under suitable conditions, or capable of binding in a Staudinger Ligation. Such a functional group may, in some embodiments, be an azide, thiol, carboxylic acid, amine, alkyne, or an epoxide. Soft matter, in this context, includes nanoparticles, organics, biologicals, polymers, proteins, sugars, oligonucleotides, peptides, antibodies, and other like components.

The prepared soft matter is mixed with a carrier to form an “ink”. In one embodiment, in addition to the features as described below, the carrier functions as a transport matrix that encapsulates the ink to form microparticles or nanoparticles and transports it to the surface to produce uniform patterns regardless of the ink solubility. The ink is then deposited by PPL onto the surface, forming a nanoreactor. In one embodiment, the nanoreactor comprises about 1 nL. In one embodiment, the kinetics of the reaction to occur in the nanoreactor is altered by characteristics of the nanoreactor. The molecular weight of the carrier may be varied. In addition, the type of carrier may be varied, such as selecting a more or less hydrophilic carrier, such as, for example, agarose. The nanoreactor includes the ink and the functional group of the substrate. The nanoreactor's boundaries are defined by the carrier and the substrate, such that the reagents are prevented from spreading across the surface over the course of the reaction, thereby preserving the sub-micrometer features of the initial deposition.

As described above, upon deposition of an ink onto a functionalized surface, any reaction may occur that results in the covalent binding of functional groups. Examples thereof include Cuaac, reductive amination, conventional ester and amide formation, or a Staudinger ligation. However, Cuaac and the Staudinger ligation are preferred embodiments.

The deposition of the ink may take place via PPL, in which the dwell time, which is the tip-substrate contact time with the surface, during patterning of the inks can be about 0.001 seconds to about 1 minute, about 0.01 seconds to about 10 seconds, about 0.05 seconds to about 8 seconds, about 0.1 seconds to about 6 seconds, about 0.5 seconds to about 4 seconds, or about 1 second to about 2 seconds. Other suitable dwell times includes, for example, about 0.001, 0.005, 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 1.5, 2, 2.5, 3, 3.5, 4, 4.5, 5, 5.5, 6, 6.5, 7, 7.5, 8, 8.5, 9, 9.5, 10, 30, and 60 seconds.

The size of the patterns synthesized by a method in accordance with embodiments of the disclosure can be controlled by varying the dwell time when patterning by PPL. The feature size dependence on dwell time exhibited when using DPN can be used to control both the size of the printed feature. For example, the feature may have a diameter that is linearly dependent on the square root of the dwell time.

In one embodiment, the nanoreactor enables a bioorthogonal reaction between the soft matter and the surface of the substrate. The use of a bioorthogonal reaction enables the selective orientation of the soft matter with regard to the substrate.

Once created, the nanoreactor may be used to carry out any number of reactions, including but not limited to catalyzed, uncatalyzed, and muticomponent reactions. It is specifically useful for bioorthogonal reactions and most especially for catalyzed reactions. Bioorthogonal reactions that may be used include, but are not limited to, Cu^{I}-catalyzed azide-alkyne cycloaddition (Cuaac), Staudinger ligation, Diels-Alder reaction, and nitrosamine reactions. For catalyzed reactions, the catalyst may be added to the ink.

The carrier is, in one embodiment, a nonreactive component of the ink. The carrier serves as a medium to facilitate diffusion. Polyethylene glycol (PEG) may be used as a carrier, other suitable carriers for certain reactions include water soluble polymers, ionic polymers, mixtures of polymers, specific carriers may include agarose or polystyrenesulfonate. In one embodiment, the carrier is in a semi-liquid state.

In one embodiment, the ink is applied to an existing layer of prepared soft matter to form a nanoreactor comprising bound soft matter and the ink to create an additional layer of soft matter bound to the initial layer.

Other components may be added to the ink and included in the nanoreactor, such as but not limited to reducing agents, oxidizing agents, catalyst ligands, catalytic metals, ion capture agents, acids, bases, lewis acids, lewis bases, radical generators, and photosensitizers.

The present invention provides the combination of a new molecular printing method, PPL, with covalent surface chemistry by inducing the site-specific reactions to provide control over ligand position, orientation, and density. The formation of new covalent bonds and the control over ligand density has been demonstrated using fluorescence and electrochemical methods. The present invention may be used with applications that include gene chips, glycan arrays, peptide arrays, sensors, and biomimetic surfaces for fundamental biological investigations.

### EXAMPLES

### Example 1

### Use of Cu^{I}-catalyzed Azide-alkene Cycloaddition in Preparation of Nanoarrays

It should be appreciated that while the covalent immobilization of fluorescent, redox-, and biologically-active alkyne-containing inks onto azide terminated surfaces by the PPL-induced site-specific Cu^{I}-catalyzed azide-alkyne cycloaddition (Cuaac) is discussed and an example of the describe apparatus, processes, and compositions, other soft matter or reactions may be used without departing from the spirit and scope of the invention. The Cuaac is a bioorthogonal reaction, proceeds quickly and in high yield, and has been adopted widely by researchers for applications in chemical biology, materials science, and nanotechnology. Additionally, this reaction involves four reagents that must all come together in the appropriate orientation and reactive form for the Cuaac to proceed, and inducing multicomponent reactions with molecular printing strategies has been a major challenge. For example, DPN or other AFM approaches have been combined with the Cuaac and other organic reactions, but these previous studies have either required complex fluid cells, metal-coated tips, or multistep patterning schemes to bring the various components together that are not scalable and produce small arrays (<100 μm²) with poor pattern quality. In one example, inks and catalysts were deposited with polymeric nanoreactors under mild conditions to create patterns with nanoscale feature diameter control over cm² areas, and the formation of new covalent bonds was confirmed by AFM, fluorescence microscopy, and potentiometric methods. One element of this approach is that the polymeric nanoreators are viscous enough to keep from spreading so nanoscale feature resolution is maintained, but they still allow reagent diffusion so multicomponent reactions proceed uniformly and reproducibly.

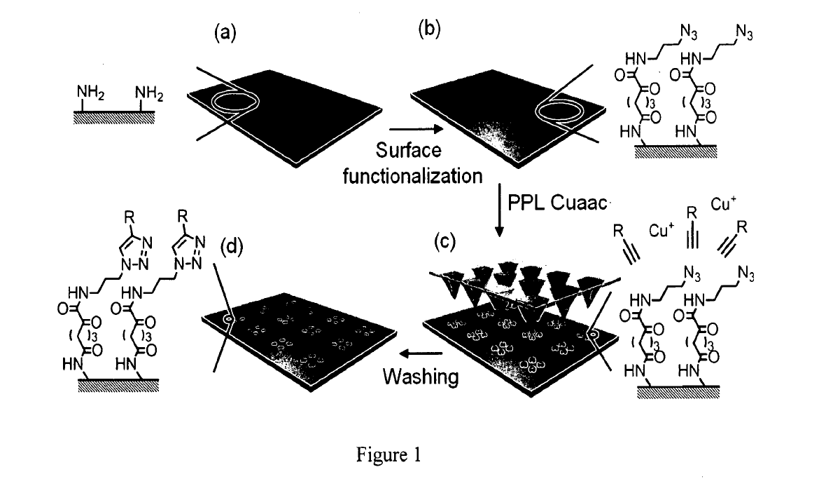

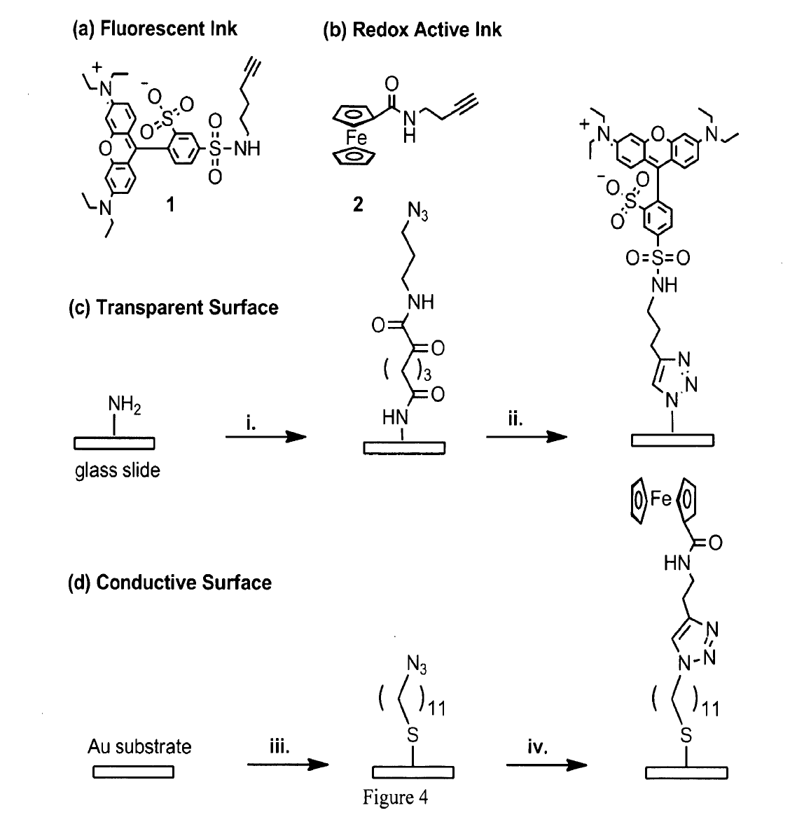

As shown in FIG. 1, Azide-terminated monolayers on glass and gold surfaces were prepared, and fluorescent and redox-active alkyne containing inks that could subsequently react with the surfaces by the Cuaac were patterned by PPL. FIG. 4A illustrates the fluorescent ink, FIG. 4B the redox ink utilized, FIG. 4c illustrates the mechanism for preparing the substrate (a glass slide) and FIG. 4D illustrates preparation of the conductive surface. To prepare the fluorescent ink 1 (FIG. 4) Lissamine rhodamine B sulfonyl chloride was reacted with 6-amino-1-hexyne following literature protocols. To prepare the redox-active ink, ferrocene carboxylic acid was reacted with 1-amino-3-butyne by a diimide coupling with dicyclohexyl carbodiimide (DCC) and dimethylaminopyridine (DMAP) to afford redox active ink 2 in a 51% yield fluorescent ink 1 was characterized by mass spectrometry, and redox active ink 2 was characterized by high-resolution mass spectrometry, ¹H and ¹³C NMR, and all spectra were consistent with the proposed structures.

To prepare the azide terminated glass surfaces needed for fluorescence experiments, amino-coated glass slides (Arrayit Corp., USA) were reacted with disuccinimidyl gluatrate (10 mM in DMF) for 24 h, washed with H₂O (50 mL), and dried in an N₂ stream to afford the succinimidyl-terminated surface. These slides were then immersed in azidopropanylamine (10 mM in DMF) for 24 h and washed with H₂O (50 mL) to afford the azido-terminated glass surface.

To prepare the azido-terminated self-assembled monolayer (SAM) on Au for electrochemical studies, 11-azido-undecane-1-thiol was prepared in three steps following published literature protocols, then Au-coated glass slides (10 nm Cr and 150 nm Au) were immersed in an ethanolic solution of 11-azido-undecane-1-thiol (1 mM) for 24 h to form the SAMs. The formation of the monolayers was confirmed by contact angle measurements, and the contact angle values obtained were consistent with literature reports.

An MA-PPL approach was adopted for these studies to render this approach facile, reproducible, and ink-general. In the present example descried herein, the PEG forms the dual purposes of transporting the ink to the surface and form the nanoreactor where the Cuaac occurs. To pattern alkyne-containing fluorescent ink 1 onto the azide-terminated glass surface, an 8,500-pen tip array, with a tip-to-tip spacing of 80 μm, was prepared following published literature procedures and exposed to O₂ plasma (Harrick PDC-001, 30 s, medium power) to make the surface of the pen-array hydrophilic and increase the adhesion of the inks to the pen arrays. To ink the tip array, 2-3 drops of CuSO₄ (1 mM in 80:20 EtOH:H₂O) and 2-3 drops of sodium ascorbate (4 mM in 80:20 EtOH:H₂O) were added to the tip arrays and allowed to sit for 1 min. Subsequently, 4 drops of a solution comprised of fluorescent ink 1 (1 mg, 1.5 μmol) and PEG (2000 g mol⁻¹, 5 mg mL⁻¹) in 80:20 EtOH:H₂O (2 mL) that was sonicated to ensure solution homogeneity, were spin coated (2000 rpm) onto the pen array.

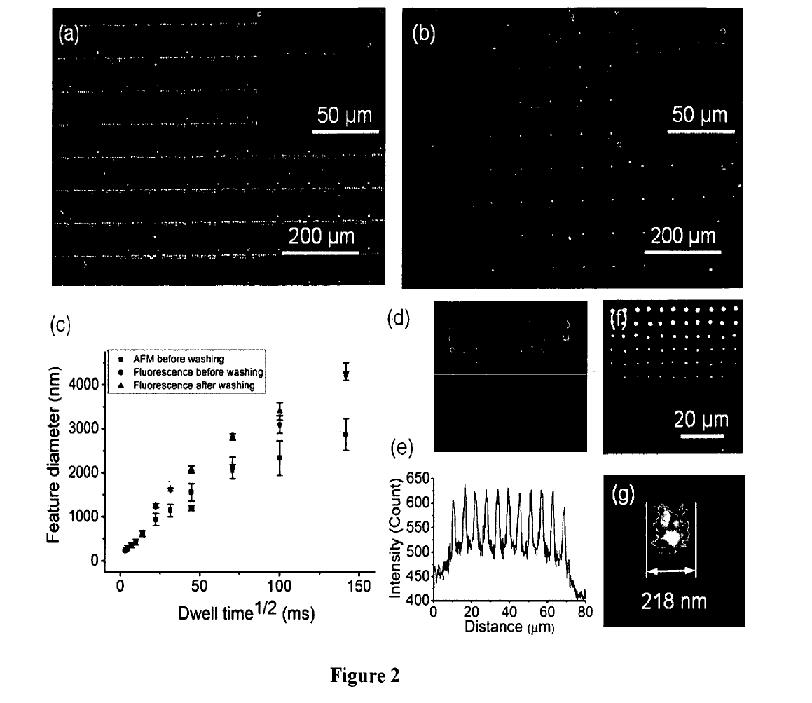

To avoid PEG crystallization, which prevents transport through the meniscus, the pens were immediately mounted onto the AFM following inking, the humidity was raised to 85-90%, and patterning was performed using a Park XE-150 AFM (Park Systems, Korea) equipped with an environmental chamber to control humidity and custom lithography software. 11×11 Dot arrays of the ink mixture were patterned by bringing the tip-arrays into contact with the azido-terminated glass surfaces with dwell-times of 10, 20, 50, 100, 200, 500, 1000, 2,000, 5,000, 10,000, and 20,000 ms (FIG. 2a). Following deposition, the PEG features containing the reaction mixture were left on the surfaces to react for 16 h, and during this period the diameter of the PEG nanoreactors were measured by noncontact AFM to have diameters of 237±24, 292±57, 362±54, 423±65, 619±63, 937±134, 1142±140, 1559±201, 2110±250, 2338±390, and 2867±360 nm, with error values reported as a standard deviation from the mean. These data demonstrate that the relationship between dwell-time and feature diameter is maintained (FIG. 2c) until high dwell times are reached, at which point the curve saturates, as has been observed previously. It should also be noted that AFM may overestimate the feature dimensions of small structures by approximately the tip radius (˜30 nm), and the smallest features with diameters measured by non-contact AFM with diameters of 218 nm (FIG. 2G), are likely to have actual diameters below 200 nm. The feature diameters and fluorescence intensity were also measured by fluorescence microscopy (Nikon Eclipse Ti, λₑₓ=532-587 nm, λ_{obs}=608-683 nm), where feature diameters of 1300±300, 2000±300, 2100±300 and 4200±300 nm for the four longest dwell times (2000, 5000, 10000, 20000 ms) were in good agreement with the AFM measurements for the shorter dwell times. However, the diameters measured by fluorescence diverge from those measured by AFM at longer dwell-times (20000 ms) because of optical aberrations and errors arising from pixel sizes in fluorescence microscopy, so the AFM measurements are likely to give more accurate measurements of feature diameters, particularly below 1 μm. The ink mixture was left on the surface for 16 h and subsequently rinsed with H₂O (50 mL) and EtOH (50 mL), and the patterns were still observable by fluorescence microscopy (FIG. 2b).

These resulting fluorescent features had nearly identical diameters after rinsing (500 ms: 1250±50, 1000 ms: 1620±40, 2000 ms: 2080±80, 5000 ms: 2820±70, 10000 ms: 3400±200, 20000 ms: 4300±200,), to those measured by fluorescence microscopy before rinsing (FIG. 2C), indicating that the diameters measured for the PEG nanoreactors are an accurate measurement of the resulting feature diameter after washing because the matrix does not spread, presumably because of the high crystallinity of PEG. The signal-to-noise values for these dots are in the range of 1.5-1.7 regardless of feature size (FIG. 2E), which is consistent with the signal-to-noise level expected for a monolayer of fluorophores. Control experiments, where no CuSO₄ was added to the ink mixture or the mixture was deposited onto an amino-terminated monolayer, did not show any measurable fluorescence following washing, confirming that 2 was immobilized onto the surface as a result of the Cuaac, and that the reaction does not occur unless all components necessary for the Cuaac reaction to proceed were present.

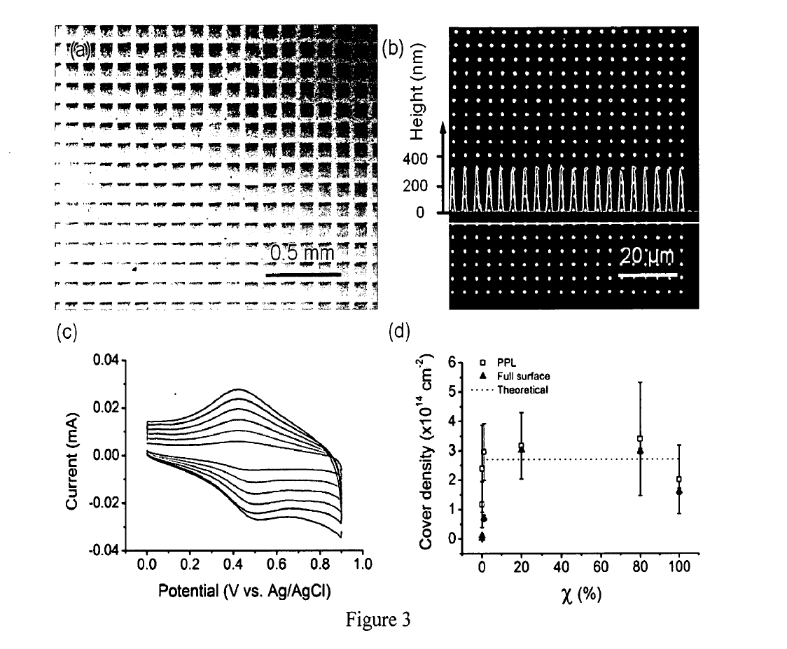

Electrochemical methods were employed to further confirm the immobilization of alkyne inks onto azide surfaces by the Cuaac and to characterize ligand density within each feature. To pattern redox active ink 2, 7000 pen PPL tip arrays with a tip-to-tip spacing of 120 μm were exposed to O₂ plasma (Harrick PDC-001, 30 s, medium power) to render their surfaces hydrophilic. Subsequently 3 drops of 1 mM CuSO₄ (80:20 EtOH:H₂O) and 2-3 drops of sodium ascorbate (4 mM in 80:20 EtOH:H₂O) were added to the pen arrays and allowed to sit 1 min before 4 drops of the ink solution comprised of redox active ink 2 (2 mg, 1.5 mmol) and PEG (2000 g mol⁻¹, 25 mg) in 5 mL of 80:20 EtOH:H₂O, that was sonicated to ensure solution homogeneity, were spin coated (2000 rpm) onto the pen array. The pen array was mounted onto the AFM, the humidity was raised to 85%, and a 20×20 do pattern was written with each pen in the array with an identical dwell time for each dot, resulting in approximately 2.7×10⁶ features cm⁻². Optical microscopy and AFM confirmed the uniformity of the pattern over large (1 mm-100 μm) (FIG. 3A) and small (<100 μm) scales (FIG. 3B), respectively. These PEG nanoreactors had an average height of approximately 300 nm and an average diameter of 1.36±0.18 μm, calculated from 10 patterns across the array to account from feature size variations that could arise from the tilting of the pen array with respect to the surface during writing.

After 16 h, the surface was washed with H₂O to remove the PEG, EtOH to remove excess ink, and 1 mM EDTA (aq) to remove excess Cu, leaving only molecules immobilized covalently onto the surface. Finally, the patterned surface was immersed in a 80:20 EtOH:H₂O solution of 1-hexyne (1.5 mM), CuSO₄ (0.1 mM), and ascorbic acid (0.2 mM) for 16 h, and subsequently washed with H₂O, EtOH, and EDTA to passivate any unreacted azides on the surface. Cyclic voltammetry (CV) was carried out using a custom built Teflon bore surface cell with an area of 0.38 cm², a Ag/AgCl reference electrode, and a Pt counterelectrode in a 1M HClO₄ (aq) electrolyte solution. The presence of the ferrocene (fc)/ferrocenium (fc⁺) reversible redox couple from redox active ink 2 was observed by CV (E^{o}=430 mV vs Ag/AgCl), thereby confirming the presence of redox active ink 2 on the surface (FIG. 3c). The peak of redox active ink 2 is shifted anodically from ferrocene because of the electron withdrawing amide linker between the ferrocene and the alkyne of redox active ink 2. Importantly, the linear relationship between scan rate and peak current confirms that redox active ink 2 is covalently immobilized onto the surface.

By integrating the peak current of the cyclic voltammagrams, the surface coverage density, Γ_{fc}, of redox active ink 2 within features on the surface could be quantified using Eq. 1:

Γ_{fc}=Q_{fc}/neA (Eq. 1)

where Q_{fc} is the total charge passed in the redox reaction, n is the change of the oxidation number of redox-active species (n=1 for fc), A is the surface area of the patterned features on the working Au electrode, and e is the electron charge. Using this approach, a density of 2.0±1.2×10¹⁴ cm⁻² was determined. For comparison, surfaces were prepared with monolayer coverage of redox active ink 2, rather than patterning by PPL, by exposing the azide-terminated Au surfaces to a solution containing redox active ink 2, CuSO₄, and ascorbic acid. Following electrochemical analysis, a Γ_{fc} of 2.0±0.2×10¹⁴ cm⁻² was obtained, which is close to the theoretical maximum density of 2.7±10¹⁴ cm⁻² for fc on a surface calculated by Chidsey. By adding the competitive alkyne 1-hexyne into the ink mixture, the peak current, and by extension the Γ_{fc} within each feature, could be tuned systematically. The percentage of redox active ink 2 in a mixed ink solution of redox active ink 2 and 1-hexyne, χ, was varied from 0.01 to 100% and patterned onto the surface by PPL to provide Γ_{fc} values ranging from 1.2±0.8×10⁻¹⁴ cm⁻² for χ of 0.01% to 3.4±1.2×10⁻¹⁴ cm⁻² for χ of 80%, and the values of Γ_{fc} were approximately equal whether the surface was patterned by PPL or immersed in the reactive solution (FIG. 3d). Interestingly, the maximum value of Γ_{fc} was observed for χ of 80% rather than χ of 100%, which may arise because the interstitial 1-hexyne pushes the ferrocene off of the reactive surface, and thereby makes more azides available for binding. Another interesting observation is that unlike the results observed by Yousaf, where the Γ_{fc} tracks linearly with χ from 0-100%, in the ink system described in the present study, Γ_{f}, reaches the predicted theoretical maximum at χ of 20%, with little variation between χ=20-80%, and a slight decrease at χ=100%. These data indicate that the ability to vary F is dependent on the molecular ratios in the ink mixture, x, rather than solely on the deposition conditions, so the inking conditions required to achieve a desired F can be optimized on a full surface in solution, and the same F should be observed when the reaction is carried out within nanoreactors.

### Example 2

### Immobilization of Carbohydrates and Other Soft Molecules onto Azido-Functionalized Glass and Gold Surfaces via Cuaac

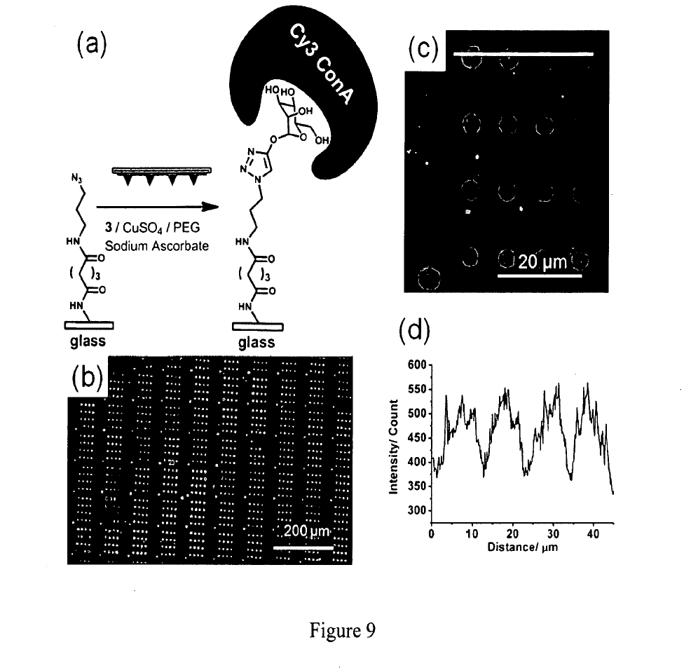

To demonstrate that the patterns produced by combining PPL with the Cuaac reaction can be used to detect sugar-lectin binding, arrays of alkyne functionalized α-D-mannose (3) were prepared according to FIG. 9a. α-D-Mannose is a monosaccharide that is over expressed on the surface of certain cancer cells and the AIDS virus, and the ability to measure the interaction between α-D-mannose and proteins in microarrays could reveal some of the biological foundations of the progressions of these diseases. Detecting binding to 3 was used as a proof-of-concept to demonstrate the utility of this patterning technique. 3 was prepared in two steps following previously reported literature protocols. To print the glycan arrays, 3 (100 mM), PEG (5 mg/mL), CuSO₄, and sodium ascorbate were spin coated onto an 8000 pen PPL array and printed at 80% humidity with a dwell time of 20 s. Subsequently, 4×4 patterns of 3 were printed onto azido-terminated glass surfaces, resulting in 4.2±0.2 μm diameter features, calculated from 10 patterns across the array, that are large enough to resolve by either fluorescence microscopy or a conventional plate reader. The variation among features arises from tilting of the pen array with respect to the surface during writing or from minor differences in tip radii. Following printing, the pattern was immersed in a solution of bovine serum albumin (BSA) to passivate the unmodified azides on the surface. Concanavalin A (ConA) is an α-mannose specific lectin that binds with a Kₐ of 5×10⁶ on a surface and is often used as a standard to confirm the activity of glycan arraying techniques. The surface was immersed in a solution of Cy3-modified ConA (0.5 mg/mL) for 5 h and washed 3 times with aqueous phosphate buffer (10 mm, pH 7.4, 0.005% Tween 20) to remove any protein that adhered nonspecifically to the surface. Upon imaging of the surface by fluorescence microscopy (λₑₓ=532-587 nm, λ_{obs}=608-683 nm), the 4×4 patterns of ConA bound to 3 were clearly observable across the cm² area of the surface (FIG. 9b, c). The signal to noise ratio of these features ranged from 1.4-1.8 (FIG. 9d), which is in the same range found upon deposition of fluorophores directly onto surfaces. Importantly, exposure of the α-D-mannose-patterned surface to Cy3 labeled glycoprotein, a protein that does not bind α-D-mannose, did not result in any observable patterns, showing that the activity of these arrays is consistent with glycan arrays prepared by conventional methods.

### Example 3

### MA-PPL Induced Staudinger Ligation Facilitates Creation of Nanoarrays of Biologically Active Probes

In addition to the Cuaac-based reaction employed as described above in Examples 1 and 2, fluorescent and redox active probes may also be covalently patterned onto azido-terminated surfaces using a PPL-induced Staudinger Ligation. Both the patterning and characterization methods used herein can be generalized to easily confirm and quantify the success of many other organic reactions on surfaces. For example, the success of the present methods as described herein substantiates that soft matter comprising a biological probe, such as a sugar, an oligonucleotide, a peptide, or an antibody, may be patterned onto azido-terminated surfaces at nanoscale dimensions.

The combination of organic reactions with MA-PPL is a five-step process involving: (1) the preparation of a reactive surface; (2) the synthesis of fluorescent and redox active molecules that react with the surface; (3) patterning of the mixture of PEG and ink molecules (fluorescent or redox active) onto the surfaces by PPL; (4) demonstration of the covalent bond formation on the surface by fluorescence microscopy and cyclic voltammetry; (5) control experiments that confirm that fluorescent and redox-active patterns form only when all components necessary for the reaction are present in the ink and on the surface.

Phosphine containing ink molecules 4 and 5 equipped with fluorescent and redox-active labels, respectively, were prepared to confirm that the Staudinger Ligation could be employed to create patterns in the context of a MA-PPL experiment. To prepare 4, rhodamine B base was reacted with 1-methyl-2-(diphenylphosphino) terephthalate and 2-(1H-7-Azabenzotriazol-1-yl)-1,1,3,3-tetramethyluronium hexafluorophosphate methanaminium (HATU) as a coupling agent, and 4 was isolated in 34% yield. To prepare redox-active ink 5, ferrocene methanol was reacted with 1-methyl-2(diphenylphosphino)terephthalate and N,N′-dicyclohexylcarbodiimide (DCC), and 5 was isolated in 34% yield. Both 4 and 5 were characterized by ¹H, ¹³C, and ³¹P NMR spectroscopies and high-resolution mass spectrometry, and all spectra were consistent with the proposed structures. The azido-terminated glass²⁰ and gold²¹ surfaces were prepared following literature protocols

To create fluorescent patterns by MA-PPL induced Staudinger Ligation, an 8500-pen tip array with a tip-to-tip spacing of 80 μm was made by following literature procedures and then exposed to O₂ plasma (Harrick PDC-001, 30 s, medium power) to render the surface of the pen-array hydrophilic prior to inking. Subsequently, 4 drops of the ink solution, comprised of 4 (1.3 mg, 1.5 mmol) and PEG (2000 g mol⁻¹, 2.5 mg mL⁻¹) in 2 mL 80:20 THF:H₂O, which was sonicated to ensure solution homogeneity, were spin coated (2000 rpm, 2 min) onto the PPL array. The inked tips were mounted onto an atomic force microscope (AFM), the humidity was raised to 75-85%, and 8×8 dot arrays with dwell times ranging from 20 to 20000 ms were patterned. The ink mixture was left on the surface for 48 hr, and the surfaces were subsequently washed with THF and H₂O.

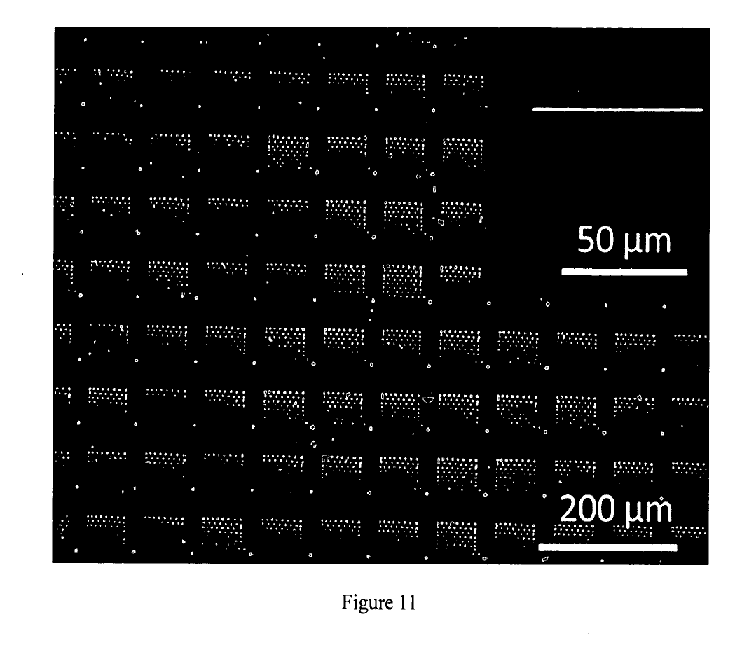

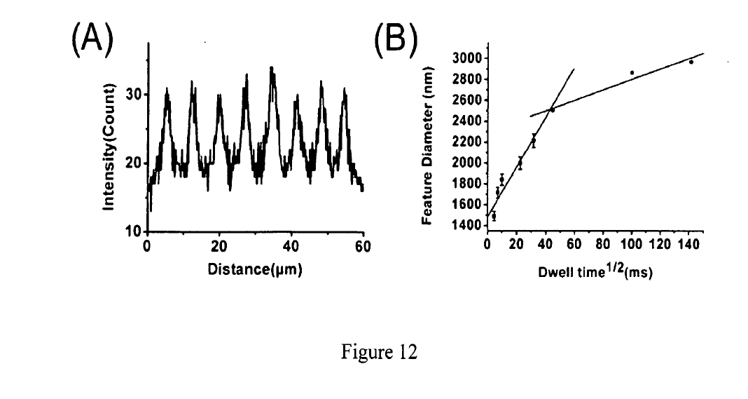

Following washing, the fluorescent images were readily observable and showed control of feature size ranging from 1.49 to 2.68 μm. A uniform pattern was prepared over the cm² area covered by the tip array (FIG. 11). Moreover, the signal to noise value for these dots in the pattern ranges from 1.5 to 1.6 (FIG. 12), which is consistent with fluorophore monolayers and a linear relationship between dwell time and feature size is observed (FIG. 12B), demonstrating the ability of PPL to control feature diameter precisely. The PEG matrix is vital to the uniform covalent immobilization of ink 4 on the solid substrate. Because of the poor solubility of 4 in the aqueous meniscus that forms between the tip and the surface, and no patterns formed in the absence of the PEG matrix. No fluorescent pattern was observed in the control experiment where ink 4 was printed onto an amino-terminated glass slide, which cannot undergo the Staudinger Ligation, confirming that fluorescent patterns were only produced because the Staudinger Ligation proceeded successfully and site specifically only on the azido-terminated surface.

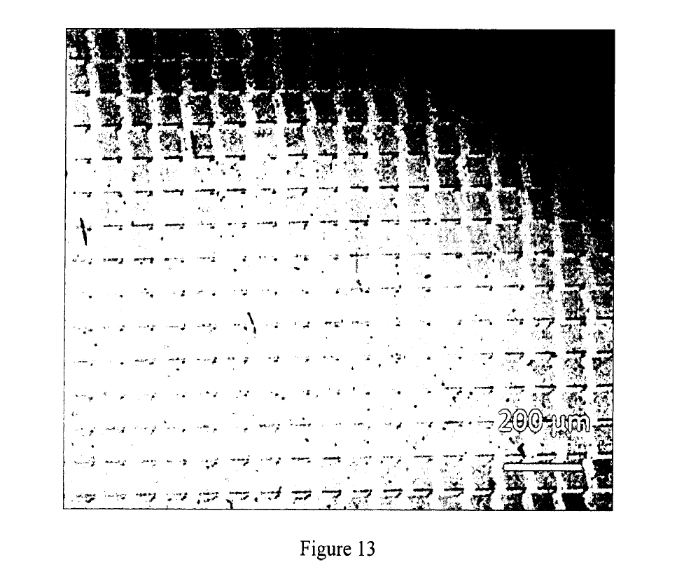

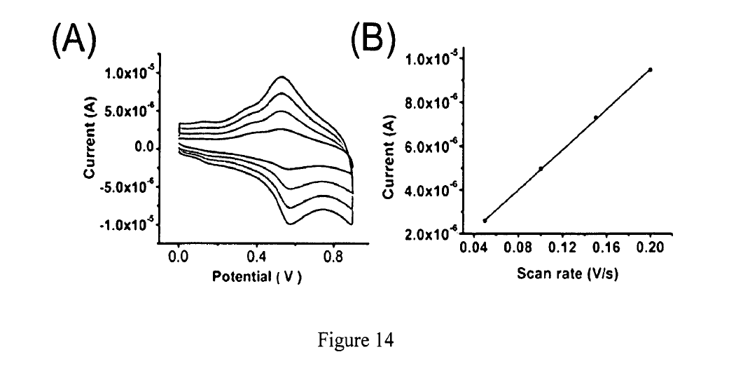

To characterize the ink density within each patterned feature, 20×20 dot arrays of 5 were patterned with each tip and with a dwell time of 10 s onto an azido-terminated gold surface following the same printing procedure described above. The uniform patterns over cm² area covered by the tip array were observed by optical microscopy (FIG. 13). After 48 h of reaction, the excess ink was washed from the surface with THF and EtOH. To confirm the presence of the redox active species, cyclic voltammetry (CV) was carried out on the patterned surface using a custom built Teflon bore surface cell with an area of 0.38 cm². A strong redox peak at E^{o}=510 mV (vs Ag/AgCl) is indicative of the presence of the ferrocene (fc)/ferrocenium (fc⁺) reversible redox couple from 5 (FIG. 14A). The anodic shift of the peak from fc is the result of the electron withdrawing ester bound to the ferrocene ring of 5 (FIG. 14A). The linear relationship between peak current and scan rates was obtained by repeating CV measurements at different potential scan rates (FIG. 14B), confirming that 5 is immobilized on the gold surface.

The surface density of fc within each feature, Γ_{fc}, was determined from the CV measurements using Eq. 2 as described above in Example 1. A Γ_{fc} of 1.99±0.03×10¹⁴ cm⁻² was obtained, which was close to the theoretical maximum cover density of a self-assembled monolayer of fc species in a self-assembled monolayer—2.7×10¹⁴ cm². A Γ_{fc} of 2.23±0.02×10¹⁴ cm⁻² was calculated when the azido-terminated gold surface was immersed in the THF solution of 5, rather than patterning by PPL, indicating the reaction proceeds to nearly quantitative yield.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

1. A system for creating an array comprising:
a substrate having a first functional group;
an ink having a carrier and soft matter with a second functional group that is complementary to the first functional group;
the substrate and the ink forming a nanoreactor, the nanoreactor confined to a reaction space bounded by the substrate and the carrier; and
the soft matter suspended in the carrier such that the soft matter is movable within the carrier and movable with respect to the first functional group of the substrate and the soft matter is prevented from spreading outside of the nanoreactor prior to a reaction between the soft matter and first functional group,
wherein the soft matter aligns to react with the first functional group to become bound to the substrate.

2. The system of claim 1, wherein the ink further includes a catalyst.

3. The system of claim 2, wherein the carrier is polyethylene glycol.

4. The system of claim 1, wherein the first functional group is an azide.

5. The system of claim 1, wherein the second functional group is an alkyne.

6. The system of claim 1, wherein the second functional group is an aryl phosphine.

7. The system of claim 1, wherein the catalyst is Cu^{I}.

8. The system of claim 1, wherein the soft matter comprises a biological probe.

9. The system of claim 8, wherein the biological probe comprises a sugar, an antibody, a peptide, and/or an oligonucleotide.

10. A system for creating an array comprising:
a substrate having a first functional group;
at least one ink having a carrier and soft matter comprising a component selected from the group consisting of fluorescent, redox active, and biologically active probe components that react with the first functional group;
the substrate and the ink covalently forming a nanoreactor, the nanoreactor confined to a reaction space bounded by the substrate and the carrier; and
the soft matter suspended in the carrier such that the soft matter is movable within the carrier and movable with respect to the first functional group of the substrate,
wherein the soft matter aligns to react with the first functional group to become covalently bound to the substrate.

11-16. (canceled)

17. A method for creating an array comprising:
preparing a substrate with a first functional group;
preparing soft matter with a second functional group complementary to the first functional group;
forming an ink comprising a carrier and the prepared soft matter;
depositing the ink on the substrate to form a nanoreactor; and
facilitating an orientation specific reaction of the first functional group and the second functional group.

18. The method of claim 17, wherein the first functional group is an azide.

19. The method of claim 17, wherein the second functional group is an alkyne.

20. The method of claim 17, wherein the second functional group is an aryl phosphine.

21. The method of claim 17, wherein the carrier is polyethylene glycol.

22. The method of claim 17, wherein forming the ink comprises adding a polymer.

23. The method of claim 17, wherein forming the ink further comprises adding a catalyst.

24. The method of claim 17, wherein the soft matter comprises a biological probe.

25. The method of claim 24, wherein the biological probe comprises a sugar, an antibody, a peptide, and/or an oligonucleotide.

26. The method of claim 17, wherein the catalyst is Cu¹.

27. The method of claim 17, wherein the carrier forms microcapsules or nanocapsules encompassing the remaining ink components.

28. The method of claim 27, wherein the microcapsules or nanocapsules define the spatial parameters of the orientation specific reaction.

29. The method of claim 17, wherein about 1 mL of ink is deposited.

30. The method of claim 17, further comprising:
preparing a second soft matter a third functional group complementary to the first functional group;

31. The method of claim 17, further comprising:
forming a second ink comprising a second carrier and the prepared second soft matter;
depositing the second ink on the substrate to form a second nanoreactor; and
facilitating an orientation specific reaction of the first functional group and the third functional group.

32. The method of claim 17, further comprising, prior to depositing, mixing the first ink and the second ink.

33. A method for creating an array comprising:
preparing a substrate with a first functional group;
preparing soft matter comprising a component selected from the group consisting of fluorescent, redox active, and biologically active probe components that react with the first functional group;
forming an ink comprising a carrier and the prepared soft matter, wherein the carrier forms microcapsules or nanocapsules encompassing the prepared soft matter;
depositing the ink on the substrate to form a nanoreactor; and
facilitating an orientation specific reaction of the first functional group and the second functional group.

34-41. (canceled)

42. The system of claim 1, wherein the substrate and ink covalently form the nanoreactor and the first functional group is covalently bound to the substrate.
